(19) United States
(12) Patent Application Publication
(10) Pub. No.: US 2026/0343402 A1
(43) Pub. Date: Oct. 29, 2026

(54) RENDEZVOUS POINT ACCESS POINT LOAD BALANCING

(71) Applicant: Cisco Technology, Inc., San Jose, CA (US)

(72) Inventors: Jerome Henry, Pittsboro, NC (US); Javier I. Contreras Albesa, Barcelona (ES); Federico Lovison, Fontanelle (TV) (IT); Domenico Ficara, Essertines-sur-Yverdon, Vaud (CH); Ugo Mario Campiglio, Morges (CH)

(21) Appl. No.: 19/645,912

(22) Filed: Apr. 13, 2026

Related U.S. Application Data
(60) Provisional application No. 63/796,465, filed on Apr. 29, 2025.

(51) Int. Cl. H04W 48/20; H04W 8/00; H04W 12/02

(52) U.S. Cl. CPC H04W 48/20; H04W 8/005; H04W 12/02

(57) ABSTRACT

A method of selecting a rendezvous point access point (RPAP) in a cluster of access points (APs). The method includes operating a cluster of access points in a wireless local area network, wherein at least some of the access points operate in a BSS privacy enhancement (BPE) mode; and selecting one of the access points in the cluster of access points to operate as a rendezvous point access point (RPAP), wherein the selecting is based on information collected by the one of the access points while operating in the wireless local area network.

### CROSS-REFERENCE TO RELATED APPLICATION

This application claims priority to U.S. Provisional Patent Application No. 63/796,465, filed Apr. 29, 2025, the entirety of which is incorporated herein by reference.

### TECHNICAL FIELD

The present disclosure relates to wireless local area networking.

### BACKGROUND

In accordance with IEEE 802.11bi Basic Service Set (BSS) Privacy Enhancements (BPE), a BPE Access Point (AP) (or, more simply, an AP) does not send regular beacons, nor does it respond to probe requests. These restrictions, intended to make the AP difficult to discover for unauthorized eavesdroppers, also make it a challenge for the AP to be discovered by legitimate candidate mobile stations (STAs). To address this challenge, Rendezvous Point APs (RPAPs) can be implemented where one AP in a cluster of n APs sends beacons and responds to probe requests with, perhaps, a randomized and changing MAC address (RCM), allowing new STAs to discover a network, associate, and then obtain information about other APs in the cluster. This mechanism is especially useful in large settings (enterprise private networks, public networks such as airports, etc.).

### BRIEF DESCRIPTION OF THE DRAWINGS

FIG. 1 is a block diagram of an operating environment for rendezvous point (RP) Basic Service Set Identifier (BSSID) based discovery, according to an example embodiment.

FIG. 2 is a signal diagram of an example RP BSSID based discovery process, according to an example embodiment.

FIG. 3 is a block diagram of the operating environment of FIG. 1 after a station (STA) performs RP BSSID based discovery, according to an example embodiment.

FIG. 4 shows a selection of a given AP as an RPAP based on a probe count, according to an example embodiment.

FIG. 5 shows selection of given APs as RPAP candidates based on a neighbor count, according to an example embodiment.

FIG. 6 is a flow chart that illustrates a process of selecting an AP as an RPAP in a cluster of APs, according to an example embodiment.

FIG. 7 is a hardware block diagram of a device configured to perform functions associated with operations discussed in connection with the embodiments described herein.

### DETAILED DESCRIPTION

### Overview

A method of selecting a rendezvous point access point (RPAP) in a cluster of access points (APs) is provided. The method includes operating a cluster of access points in a wireless local area network, wherein at least some of the access points in the cluster operate in a Basic Service Set (BSS) privacy enhancement (BPE) mode, collecting information from the at least some of the access points in the cluster while operating in the wireless local area network, and selecting one of the access points in the cluster of access points to operate as a rendezvous point access point (RPAP) based on the information.

In another embodiment, a device is provided. The device includes an interface configured to enable network communications, a memory, and one or more processors coupled to the interface and the memory, and configured to: operate a cluster of access points in a wireless local area network, wherein at least some of the access points in the cluster operate in a Basic Service Set (BSS) privacy enhancement (BPE) mode, collect information from the at least some of the access points in the cluster while operating in the wireless local area network, and select one of the access points in the cluster of access points to operate as a rendezvous point access point (RPAP) based on the information.

### Example Embodiments

The Institute of Electrical and Electronics Engineers (IEEE) 802.11bi draft standard is being developed for defining new mechanisms to improve user privacy in wireless networks (e.g., Wi-Fi networks). These Enhanced Privacy Protection (EPP) mechanisms include station (STA) (e.g., client device) specific mechanisms and network device mechanisms for various devices of the network, such as for the devices of a Basic Service Set (BSS). A BSS typically includes an Access Point (AP) and one or more associated stations (STAs).

Mechanisms focused on enhancing STA privacy are designated as Client Privacy Enhancement (CPE). CPE mechanisms prevent the identification and tracking of STAs and are primarily coordinated and managed by the STA itself. CPE mechanisms enable STAs to obfuscate their identity, including their Media Access Control (MAC) address and other identifying elements.

Mechanisms that protect devices of an entire BSS (i.e., the AP and associated STAs) are designated as BSS Privacy Enhancements (BPE). BPE mechanisms prevent identification and tracking of the entire BSS and are coordinated and managed by APs and other network infrastructure devices, such as a Wireless Local Area Network (WLAN) controller, or another network controller. BPE mechanisms enable APs to protect privacy by not transmitting discovery information (e.g., Service Set Identifier (SSID), capability elements, or operation elements) clearly over the air, not responding to legacy probe requests, and rotating the AP's MAC address and/or BSS identifier (BSSID).

In traditional wireless networks without privacy enhancements, STAs discover available networks through active or passive scanning. In passive scanning, STAs listen for beacon frames periodically broadcast by APs, which include the SSID, BSSID, and capability information. In active scanning, STAs broadcast probe request frames, and APs respond with probe response frames containing similar discovery information. However, BPE mechanisms fundamentally disrupt both discovery methods because BPE APs do not broadcast discovery information in beacon frames nor do they respond to legacy probe requests. Therefore, STAs cannot identify and connect to BPE-enabled networks using conventional discovery procedures.

In small-scale deployments, such as a virtual AP hosted on a client device, the STA may be pre-configured with parameters enabling the STA to discover the BPE-enabled AP. The provisioning can also occur out-of-band (OOB) (e.g., via short-range wireless communication). However, in larger-scale deployments, such as a public venue with a wireless network requiring both CPE and BPE (e.g., where the venue operator desires to provide network access to customers while preventing crowd-sourcing companies from easily mapping the venue), STAs need to be able to discover the network before enabling 802.11bi modes. Without a discovery mechanism, STAs cannot access BPE-enabled wireless networks. No existing solutions enable a STA to discover a network that implements both CPE and BPE mechanisms. To address this issue, and as described herein, rendezvous point (RP) BSSID-based discovery is implemented to enable STAs to discover such wireless networks.

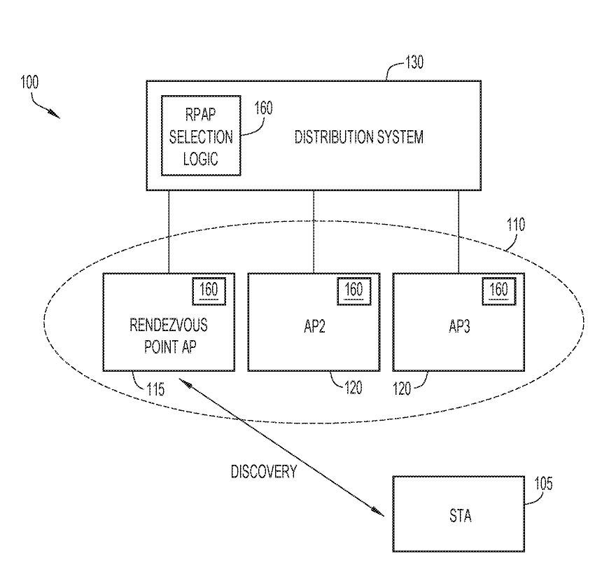

FIG. 1 is a block diagram of an operating environment 100 for RP BSSID-based discovery. The operating environment 100 includes a STA 105, an AP cluster 110, and a distribution system, or DS 130. An AP cluster 110 comprises a rendezvous point AP (RPAP) 115 and zero or more additional APs 120. In the illustrated embodiment, the AP cluster further includes AP2 120 and AP3 120. The RPAP 115 and the APs 120 utilize BPE mechanisms as part of a BPE-enabled wireless network, so that STA 105 is unable to perform traditional active or passive scanning techniques to discover the network. The components of operating environment 100 cooperate to enable the STA 105 to discover and access the BPE-enabled wireless network using an RP BSSID-based discovery mechanism.

The STA 105 is a client device seeking to discover and connect to a wireless network that implements BPE mechanisms. The STA 105 may be any wireless-enabled device, such as a smartphone, tablet, laptop computer, IoT device, or other computing device capable of wireless communication according to IEEE 802.11 standards. The STA 105 is configured to perform RP BSSID-based discovery procedures to identify BPE-enabled networks that would otherwise be undiscoverable using conventional active or passive scanning methods. In certain embodiments, the STA 105 is a multi-link device (MLD) capable of simultaneously operating across multiple communication links, such as links operating on different frequency bands (e.g., 2.4 GHz, 5 GHz, 6 GHz) or different channels. As an MLD, the STA 105 may discover and establish connections with multiple APs or multiple links of a single AP MLD within the AP cluster 110.

The RPAP 115 is a specially-configured AP within the AP cluster 110 that serves as a rendezvous point for STAs seeking to discover the BPE-enabled network. To maintain BPE privacy requirements, the RPAP 115 may not respond to legacy broadcast probe requests, nor respond to unicast probe requests that mention a specific, non-802.11bi BSSID, and may not transmit beacons. The RPAP 115 coordinates with the other APs 120 and the DS 130 to facilitate network discovery while maintaining privacy protections for the overall BSS.

It is noted that any of the APs 120 could function as the RPAP and, as will be described more fully below, RPAP selection logic 160, which may be deployed on the APs 120, as well as, perhaps, within DS 130 or on a controller, is employed to determine and designate which AP, among the APs 120 in AP cluster 110, is to act, operate, and/or function as the RPAP 115 at any given time.

In certain embodiments, the RPAP 115 is a MLD that operates across multiple communication links. As an MLD, the RPAP 115 may enable RP BSSID-based discovery on one or more of its links. In example implementations, the RPAP 115 enables RP BSSID-based discovery using a link operating on the 2.4 GHz frequency band because the 2.4 GHz band provides a wider coverage range than other frequency bands and ensures compatibility with STAs that scan the 2.4 GHz band first or exclusively during discovery procedures. After initial discovery on the 2.4 GHz band, the RPAP 115 may provide information about additional available links operating on other frequency bands (e.g., 5 GHz, 6 GHz) to support multi-link connectivity.

The APs 120 are additional APs within the AP cluster 110 that operate with BPE mechanisms enabled. These APs 120 provide wireless network access to authenticated and associated STAs while implementing privacy-enhancing features such as address rotation, restricted beacon information, and selective response to discovery requests. The APs 120 communicate with the RPAP 115 and the DS 130 to coordinate network operations and discovery procedures. In certain embodiments, one or more of the APs 120 are MLDs capable of operating across multiple communication links simultaneously. When configured as MLDs, the APs 120 can provide multi-link connectivity to MLD STAs (e.g., the STA 105) while maintaining BPE protections across all links.

The DS 130 is a network infrastructure component that interconnects the APs within the AP cluster 110 and may provide connectivity to external networks. The DS 130 may include or communicate with network management devices such as a WLAN controller or another network controller that coordinates BPE and CPE mechanisms across the AP cluster 110. In this regard, RPAP selection logic 160 could also be deployed within the DS 130, on the WLAN controller, or on yet another network controller.

APs 120 (including the RPAP 115) within the AP cluster 110 detect one another through beacon reception, neighbor discovery messages or protocols, or coordination through the DS 130. The clustering may be managed automatically through distributed algorithms executed by the APs themselves, or centrally through a WLAN controller or network management system communicating via the DS 130. Factors influencing AP cluster 110 formation include RF signal strength between APs, physical distance, overlapping coverage areas, and administrative configuration. The formation of the AP cluster 110, in accordance with an embodiment, also includes designating one or more RPAPs 115 within the AP cluster 110 to support RP BSSID-based discovery for the BPE-enabled network.

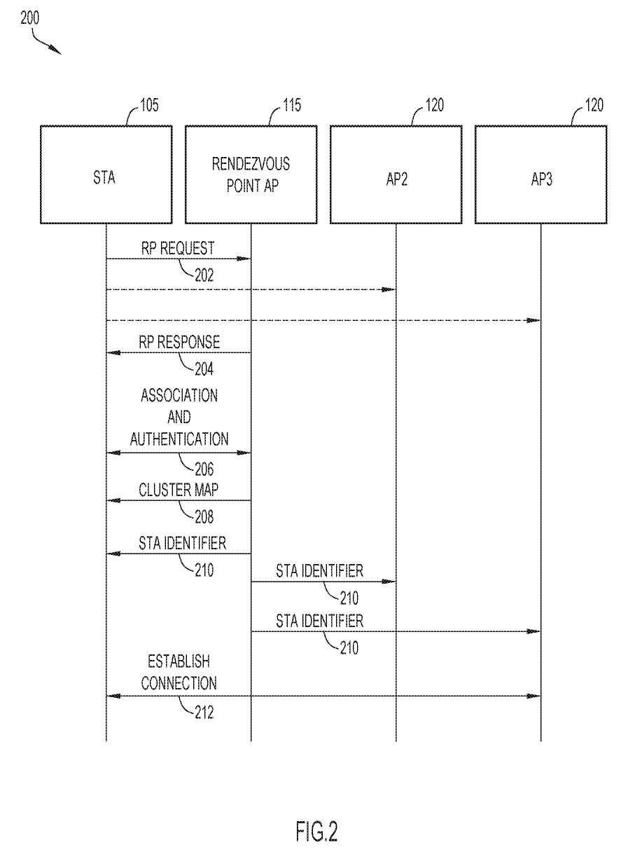

FIG. 2 is a signal diagram of an example RP BSSID-based discovery process 200. The process 200 demonstrates the message exchanges between the STA 105, the RPAP 115, and the APs 120 of the AP cluster 110 to enable the STA 105 to discover and connect to a BPE-enabled wireless network. The process 200 includes a rendezvous point or RP request operation 202, an RP response operation 204, an association and authentication operation 206, a cluster map operation 208, a STA identifier operation 210, and a connection establishment operation 212.

At operation 202, the STA 105 transmits an RP request (e.g., an RP probe request). The RP request is a wireless transmission that may be received by multiple devices within RF range. In the illustrated embodiment, the RPAP 115 receives the RP request as the intended recipient. Additionally, AP2 120 and AP3 120 may also receive the RP request if they are within range to detect the transmission. However, as previously described, only the RPAP 115 will respond to the RP request because the other APs 120 are not designated as rendezvous points. It is noted that the STA 105 will likely broadcast the probe request containing an onboarding SSID name. The STA 105, at this point, does not need an Identity Key to send the RP request. Eventually, the STA 105 will need an Identity Key to identify if it can connect to a network advertised in the probe response, discussed next. Notably, it is unlikely for the STA 105 to know the BSSID of the RPAP 115 because this will likely be rotating for BPE APs.

At operation 204, the RPAP 115 transmits an RP response to the STA 105. The RP response provides information that enables the STA 105 to identify networks of interest and determine available discovery and authentication mechanisms. The RP response is used by the STA 105 to learn possible SSID names of networks available in the AP cluster 110 and to determine whether, for example, Access Network Query Protocol (ANQP) support is available for those networks.

In some embodiments, the RP response includes only hashed SSID names rather than plaintext SSIDs. The hashed SSIDs maintain privacy while allowing the STA 105 to identify networks for which it has credentials by computing and comparing hash values. In other embodiments, the RP response includes one or more SSID values in plaintext or encrypted form, enabling the STA 105 to directly identify available networks and APs.

In certain embodiments, the RP response includes a flag associated with each BSSID to indicate support for, e.g., Generic Advertisement Service (GAS) protocols, such as those used in IEEE 802.11u, OpenRoaming, or Passpoint implementations. When the flag indicates GAS support for a particular BSSID, the STA 105 may initiate a Pre-Association Security Negotiation (PASN) process with that BSSID to establish a protected channel for conducting a secure ANQP exchange. This enables the STA 105 to query network information (such as roaming consortiums, venue information, or network capabilities) in a privacy-protected manner before associating with the network.

In some embodiments, the RP response is formatted as a protected beacon frame rather than a conventional probe response. The protected beacon frame format provides enhanced security and privacy for the discovery information transmitted to the STA 105. When the STA 105 receives the RP response and identifies a network for which it has a pre-existing pre-shared identity key, valid credentials, or a stored profile, the STA 105 can proceed directly to association and authentication with the RPAP 115 using the RP BSSID address.

At operation 206, the STA 105 and the RPAP 115 perform an association and authentication process. This process occurs when the STA 105 has identified a network for which it possesses authentication credentials, such as a pre-existing pre-shared identity key, valid credentials (e.g., username and password, certificate), or a stored network profile. The STA 105 initiates association with the RPAP 115 using the RP BSSID as the target address. Following successful association, the STA 105 and RPAP 115 complete an authentication exchange using the appropriate authentication method (e.g., WPA2, WPA3, 802.1X, SAE). The association and authentication process establishes an authenticated, trusted, and protected communication channel between the STA 105 and the RPAP 115. This protected channel enables secure transmission of sensitive network information in subsequent steps.

At operation 208, the RPAP 115 transmits a cluster map to the STA 105 over the protected connection established in operation 206. The cluster map provides the STA 105 with information about the BPE-enabled network topology in the local RF area (e.g., the AP cluster 110), enabling the STA 105 to identify available APs for subsequent connection. In some embodiments, the cluster map is formatted as a Reduced Neighbor Report (RNR) element that includes information about neighboring APs and their BSSIDs. In other embodiments, the cluster map is formatted as a protected IEEE 802.11k neighbor report that provides detailed information about neighboring APs within the AP cluster 110. The cluster map may include information about multiple physical AP devices within the AP cluster 110, or it may describe only the RPAP 115 itself if the RPAP 115 operates as a multi-link or multi-BSSID device. The cluster map includes protected BSSIDs for the neighboring APs (i.e., the actual BSSIDs used by BPE-enabled APs 120 for operational communications, as distinct from the RP BSSID used for discovery), as well as security information and policy information for each AP. The security information may include supported authentication methods, encryption algorithms, and security capabilities. The policy information may include access policies, quality of service parameters, load information, or connection preferences.

At operation 210, the RPAP 115 transmits a STA identifier to both the STA 105 and the APs 120 within the AP cluster 110. The STA identifier enables the STA 105 to subsequently associate with BPE-enabled APs 120 in the AP cluster 110 by providing an identifier that is known and accepted by those APs. Without such an identifier, the BPE-enabled APs 120 would not respond to or accept connections from the STA 105 due to their privacy-protecting operational mode. Thus, the device identifier may serve as a credential or token that the STA 105 can present to BPE-enabled APs 120 to prove that it has been authorized through the discovery process. In some embodiments, the RPAP 115 generates the device identifier for the STA 105 and transmits this identifier to the STA 105 over a protected management frame. The RPAP 115 may transmit the protected management frame over the secure connection established in operation 206 in example implementations. The device identifier may be generated using methods defined in IEEE 802.11bh or other suitable identifier generation mechanisms. The RPAP 115 may share the device identifier with the APs 120 via the DS 130 or through direct inter-AP communication.

In certain embodiments, the RPAP 115 may implement frame anonymization procedures. After the STA 105 associates with the RPAP 115 in operation 206, the STA 105 and the RPAP 115 may negotiate and agree upon a STA MAC address rotation scheme as part of the frame anonymization procedures. The MAC address rotation scheme defines parameters such as rotation timing, the method for generating rotated MAC addresses, synchronization mechanisms, and the scope of addresses to be used. The RPAP 115 then shares the agreed-upon MAC address rotation scheme with the neighboring BPE-enabled APs 120 in the cluster, enabling the APs 120 to recognize and accept connections from the STA 105 as it rotates through different MAC addresses. This coordinated privacy protection is provided for both the STA 105 through MAC address rotation and the network infrastructure through BPE mechanisms.

At operation 212, the STA 105 performs a connection establishment process with one of the APs 120 in the AP cluster 110, illustrated as AP3.

Thus, those skilled in the art will appreciate that the purpose of the RPAP 115 is to enable the STA 105 to discover BPE-enabled networks and obtain the necessary credentials and network information so that an AP 120 can provide full data communication services to the STA 105. However, the STA 105 may determine to connect with the RPAP 115 for full communication services in example implementations (e.g., when the RPAP 115 is the closest AP and/or can provide the best connection of the devices in the AP cluster 110). Once the STA 105 receives the cluster map and the STA identifier, the STA 105 has obtained all material necessary to discover and connect to the neighboring BPE-enabled APs 120 in the AP cluster 110. The STA 105 then establishes a connection with one of the APs (the RPAP 115 or an AP 120) operating in full IEEE 802.11bi mode.

To establish the connection with AP3, the STA 105 uses the information provided in the cluster map to identify AP3 and obtain its protected BSSID and connection parameters. The STA 105 then initiates any necessary association and authentication procedures with AP3 according to the procedures defined in the IEEE 802.11bi standard, presenting the STA identifier received from the RPAP 115 to prove its authorization. Upon successful authentication and association, the STA 105 establishes a data communication connection with AP3 for transmitting and receiving network traffic. The STA 105 and AP3 may operate in BPE mode, implementing privacy-enhancing mechanisms such as address rotation and restricted information disclosure.

The RP BSSID-based discovery process 200 enables a STA 105 to enter a new venue or RF area, discover BPE-enabled networks that would otherwise be hidden from conventional discovery procedures, authenticate with a rendezvous point, receive necessary network topology and credential information, and establish a connection with a BPE-enabled AP to communicate via the wireless network while maintaining privacy protections for both the STA 105 and the network infrastructure.

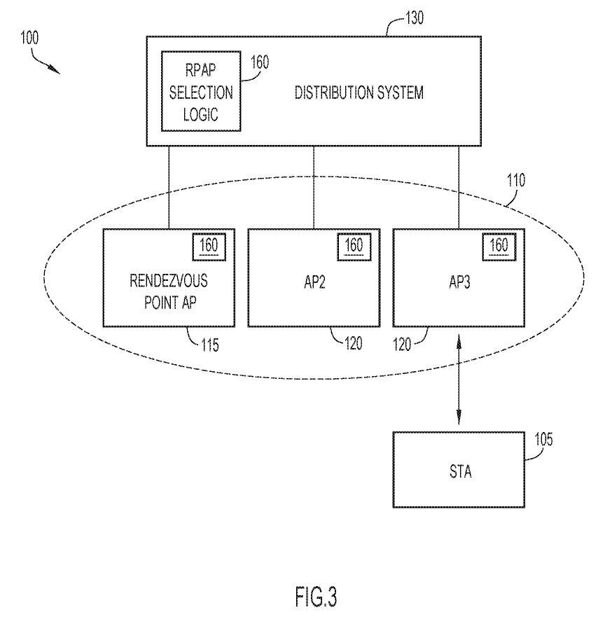

FIG. 3 is a block diagram of the operating environment 100 after the STA 105 performs RP BSSID-based discovery as described above. As noted, following receipt of the RP probe response from the RPAP 115, the STA 105 obtains information necessary to authenticate and associate with one or more BPE-enabled APs 120 within the AP cluster 110. Using the network information provided in the RP probe response (such as encrypted SSIDs, security parameters, connection parameters, and AP identifiers), the STA 105 can connect to an AP 120 in the AP cluster 110 while operating in BPE mode for secure wireless network communication. As indicated in FIG. 2, and illustrated in FIG. 3, the STA 105 authenticates and associates with AP3, establishing a wireless connection for data communication.

As mentioned, the STA 105 engages with the RPAP 115 to learn about and gain access to the overall AP cluster 110. However, it is noted that using a given AP as the RPAP 115 for too long may allow an eavesdropper to locate the RPAP 115, thus defeating one goal of BPE. At the same time, the RPAP 115 cannot stop operating while a STA 105 is connected. To address these issues, and further enhance BPE offerings, described next are mechanisms, executed at least in part by RPAP selection logic 160, to choose one of the APs 120 as the RPAP 115 and to operate the chosen or selected RPAP to maintain the desired privacy afforded by BPE.

As previously noted, BPE aims to protect the privacy of the AP in addition to that of the STA. There are several reasons that might drive large venues to implement BPE. For example, many venues want their customers to use a venue app (so as to engage with these customers). Therefore, the venue owners may want to discourage venue mapping with crowd-sourcing applications (such as Google Maps and the like).

802.11bi CPE protects the privacy of the STA, but not that of the AP. Therefore, the roles of STA and AP are fairly clear, which puts a ceiling on the protection (“if it rotates its MAC, it’s your target”). Adding BPE increases the privacy protection for the STA and its owner, because the roles (AP or STA) become blurred.

Many venues deploy temporal and/or mobile networks and do not want a static association between these networks and their venue, for many reasons. With a visible SSID and static BSSIDs for the duration of the deployment, this association becomes unavoidable (as most smartphones collect crowdsourcing data that the user cannot prevent).

In some scenarios, event owners may have a “network kit” that travels around the world. Third-party service providers may map these network kits to a specific time zone, triggering wrong time settings on client devices, as the same AP is seen in different parts of the world.

Another scenario that may need BPE functionality is when the network owner has extreme privacy requirements, and may not want the network position or availability to be mapped for security reasons. Such a scenario may be applicable to, for example, military or other sensitive network deployments.

Therefore, deploying BPE in a public venue enables obfuscation of the SSID and prevents eavesdroppers from finding the location of the APs deployed within the venue.

That said, deploying BPE in such environments should not prevent legitimate STAs from discovering and associating to a network. In this regard, the RPAP 115 responds to probes from an RCM and a possible SSID, allowing a STA to discover a network and connect, and then, once secure links are established, obtain information about the BPE APs in the AP cluster 110. The STA may then disconnect from the RPAP 115.

Given the above, and in accordance with an embodiment, the role of the RPAP 115 may be treated as a temporal role, where a given AP acts as the RPAP 115 for the AP cluster 110, perhaps for only a certain period of time, and is selected based on one or more conditions.

In a first RPAP selection embodiment, RPAP selection logic 160 is configured to select a given AP as the RPAP 115 based on probe detection.

In the AP cluster 110, a single AP is designated for the RPAP role. This is because, if the RPAP role were to be implemented on different APs (at the same time or in turn), an observer would just need to wait to map the entire venue. When a single AP, at a time, per cluster is designated as the RPAP 115, the observers might detect the existence of one AP, but do not easily discover the other AP devices.

In this embodiment, when a network is deployed, the RPAP assignment or designation is part of an RRM (Radio Resource Management) function. During an initial training and stabilization period where the APs 120 discover one another and set up their initial channels, RPAP selection logic 160 is configured to record a count of received probe requests.

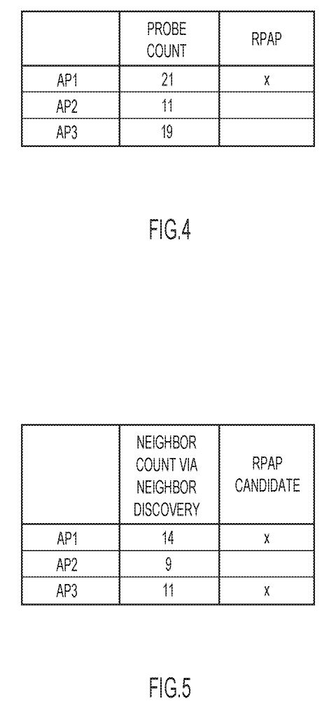

The probe count is associated with the RF neighborhoods formed with RRM. In many cases, the RF neighborhood is a discontinuous space wherein AP1 hears AP2, which hears AP3, but AP1 and AP3 do not hear each other. Thus, in this embodiment, RPAP selection logic 160 is configured to form an RPAP cluster by centering each cluster on the AP that received the highest count of probe requests in the training period. Probe counting may last only a few minutes, until such time as one of the APs 120 is selected as the RPAP 115. As shown in FIG. 4, AP1 has the highest recorded probe count, thus making AP1 the focus of the cluster. As such, RPAP selection logic 160 designates AP1 as the RPAP 115, and all other APs that successfully exchange bi-directional NDP messages with AP1, including other APs that received a large (but smaller than AP1’s) count, form the rest of the AP cluster 110. It is envisioned that the radio with the largest span (e.g., 2.4 GHz) is chosen as the radio of reference for cluster formation.

In an embodiment, during the lifespan of the RPAP clusters, the APs continue counting the probe requests they receive. The RPAP function may then be passed to another AP if the AP that was first chosen is no longer the best candidate, i.e., another AP has a higher number of counted probe requests. It is expected that this change will not happen often.

Once RPAP selection logic 160 designates the RPAP 115, that AP starts implementing the RPAP function. For a network to be easily discoverable, one embodiment may have the RPAP 115 broadcast beacon messages. The RPAP 115 then starts sending beacon messages as the RPAP function starts. In another embodiment, the RPAP 115 does not send any beacon until a first probe request is received by the RPAP 115. The RPAP 115 then responds to the probe request and also starts sending beacons for a (configurable) time interval (herein static MAC beacon interval, SMBI), then stops if no new probe requests are received.

The beacons may be sent from an RCM address, and display minimal information. In one embodiment, the SSID is a static string, and, e.g., defined in the 802.11bi standard (e.g., BPE onboarding). In another embodiment, the SSID is a string randomly selected from a pool of possible SSID strings configured on the RPAP 115, which indicate the intent of the network (e.g., “public Wi-Fi”, “Wi-Fi”, “Venue” etc.). In another embodiment, the SSID is a hash of the original string (and included, e.g., in a Reduced Neighbor Report information element). In yet another embodiment, the SSID is a regular SSID string. The AP also indicates support for BPE (thus indicating that it hosts information on BPE APs in the ESS).

In an embodiment, the RPAP 115 uses a single RCM and SSID value pair while a STA 105 is onboarding. Once the STA 105 has completed onboarding and has been disconnected, the RPAP 115 only continues advertising the same BSSID/SSID, for up to one SMBI, if other STAs 105 are probing. If no other STAs 105 are probing, or at the end of the SMBI, the RPAP 115 may spin a new RCM, pick a new public SSID string, and start using that new pair in subsequent beacons.

The STA 105 disconnection is part of the RPAP 115 role. As soon as the STA 105 has joined the temporal SSID and established an authenticated and secured connection with the RPAP 115, the RPAP 115 passes to the STA the material it needs to discover neighboring BPE APs, as explained previously. In addition, or alternatively, the RPAP 115 may indicate the neighboring BPE AP(s) BSSID for the current and the next epoch, with or without information on the epoch duration or characteristics. Such an approach allows the STA 105 to attempt to join either of the provided BSSIDs, without revealing information about the BPE epoch structure. Once the material is conveyed to the STA 105, the RPAP 115 then sends a disassociation frame to the STA 105.

The first RPAP selection embodiment was based on probe count. In a second RPAP selection embodiment, RPAP selection logic 160 is configured to select a given AP as the RPAP 115 based on or derived from neighbor discovery messages or protocols.

Specifically, after network setup, APs 120 discover each other through RRM functions, and establish a RF relationship. Each AP 120 has a set of neighbors based on how each AP 120 hears one another. The detection may be through listening to other APs’ normal beacons, or by sending specific frames (Neighbor Discovery messages) or by other AP-to-AP exchanges.

As shown in FIG. 5, the APs 120 that have the largest number of neighbors, as determined via neighbor discovery, may be selected as RPAP candidates, as they have the most “central” RF locations.

APs 120 that are on the edge of the neighborhood, or are isolated, may become RPAP candidates as well, as an edge or backup RPAP.

In an embodiment, the RPAP candidates (e.g., AP1 and AP3 in FIG. 5) may perform the RPAP function (one at a time), and may rotate in a cyclic or random fashion, to make it more difficult to perform passive mapping of the network.

The embodiments described herein thus present approaches and methodologies to distribute the role of the RPAP 115 in a BPE 802.11bi context and a more-than-one AP venue. The embodiments, executed at least in part by RPAP selection logic 160, enable the discovery of BPE APs without revealing consistent and statistically usable information about the APs in the venue.

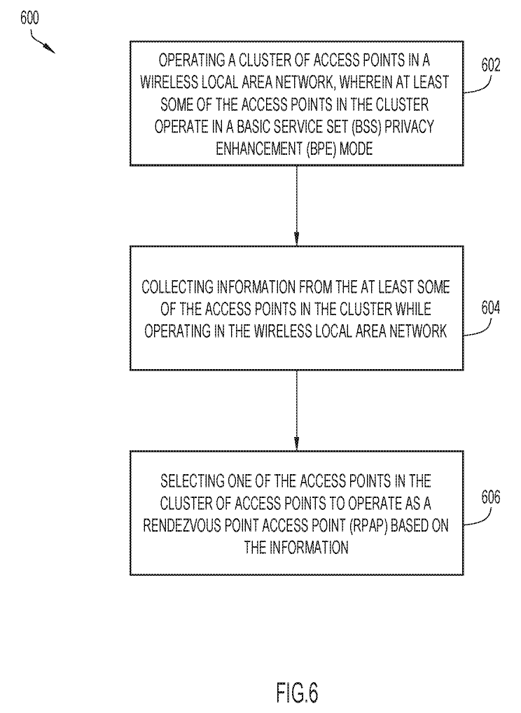

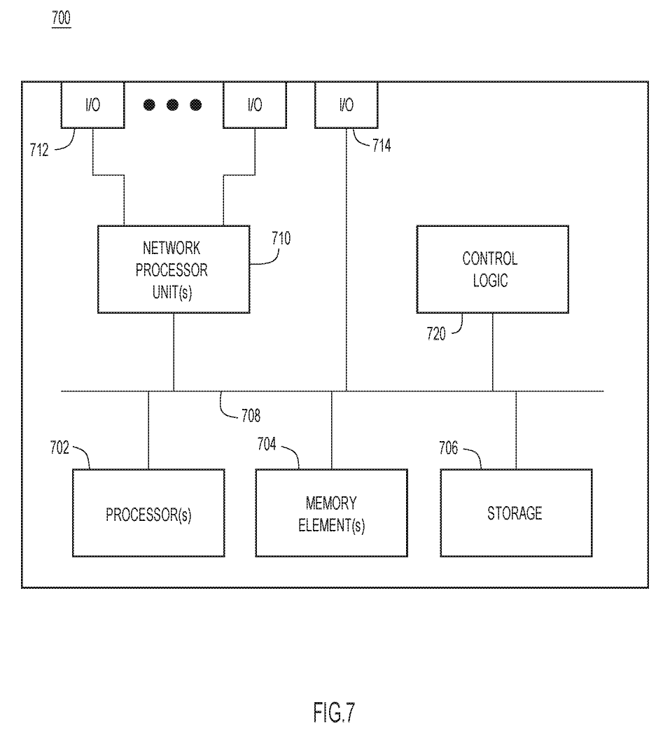

FIG. 6 is a flowchart that illustrates a process 600 of selecting an AP as an RPAP in a cluster of APs, according to an example embodiment. At 602, an operation includes operating a cluster of access points in a wireless local area network, wherein at least some of the access points in the cluster operate in a Basic Service Set (BSS) privacy enhancement (BPE) mode. At 604, an operation includes collecting information from the at least some of the access points in the cluster while operating in the wireless local area network. And, at 606, an operation includes selecting one of the access points in the cluster of access points to operate as a rendezvous point access point (RPAP) based on the information.

FIG. 7 is a hardware block diagram of a device configured to perform functions associated with operations discussed in connection with the embodiments described herein. In various embodiments, a computing device, such as computing device 700 or any combination of computing devices 700, may be configured as any entity/entities as discussed for the techniques depicted in connection with FIGS. 1-6 in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720 (which could be RPAP selection logic 160). In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations, and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of the potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data, and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read-only memory (ROM), erasable programmable read-only memory (EPROM), application-specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that are capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with the teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly be connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc., which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores, or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic, or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combinations of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further, as referred to herein, 'at least one of' and 'one or more of' can be represented using the '(s)' nomenclature (e.g., one or more element(s)).

In sum, a method may include operating a cluster of access points in a wireless local area network, wherein at least some of the access points in the cluster operate in a Basic Service Set (BSS) privacy enhancement (BPE) mode, collecting information from the at least some of the access points in the cluster while operating in the wireless local area network, and selecting one of the access points in the cluster of access points to operate as a rendezvous point access point (RPAP) based on the information.

In the method, the information may be a number of probe requests received by the access points in the cluster of access points.

In the method, the information may be derived from neighbor discovery messages.

The method may further include periodically rotating a media access control (MAC) address of the RPAP.

The method may further include selecting another access point in the cluster of access points to operate as the RPAP based on information collected by the another access point in the cluster of access points while operating in the wireless local area network.

In the method, the information collected by the another access point in the cluster of access points includes a higher number of probe requests counted compared to a number of probe requests counted by the one of the access points in the cluster of access points.

The method may further include identifying at least two access points in the cluster of access points as candidate RPAPs.

The method may further include successively operating, one at a time, the candidate RPAPs.

The method may further include operating each candidate RPAP for a random period of time.

The method may further include collecting the information collected by the one of the access points during a training and stabilization period for the wireless local area network.

In another embodiment, a device may include an interface configured to enable network communications, a memory, and one or more processors coupled to the interface and the memory, and configured to: operate a cluster of access points in a wireless local area network, wherein at least some of the access points in the cluster operate in a Basic Service Set (BSS) privacy enhancement (BPE) mode, collect information from the at least some of the access points in the cluster while operating in the wireless local area network, and select one of the access points in the cluster of access points to operate as a rendezvous point access point (RPAP) based on the information.

In the device, the information may be a number of probe requests received by the access points in the cluster of access points.

In the device, the information may be derived from neighbor discovery messages.

In the device, the one or more processors may be further configured to periodically rotate a media access control (MAC) address of the RPAP.

In the device, the one or more processors may be further configured to select another access point in the cluster of access points to operate as the RPAP based on information collected by the another access point in the cluster of access points while operating in the wireless local area network.

In the device, the information collected by the another access point in the cluster of access points includes a higher number of probe requests counted compared to a number of probe requests counted by the one of the access points in the cluster of access points.

In the device, the one or more processors may be further configured to identify at least two access points in the cluster of access points as candidate RPAPs.

In still another embodiment, one or more non-transitory computer readable storage media are encoded with instructions that, when executed by a processor, cause the processor to: operate a cluster of access points in a wireless local area network, wherein at least some of the access points in the cluster operate in a Basic Service Set (BSS) privacy enhancement (BPE) mode, collect information from the at least some of the access points in the cluster while operating in the wireless local area network, and select one of the access points in the cluster of access points to operate as a rendezvous point access point (RPAP) based on the information.

The information may be a number of probe requests received from the access points in the cluster of access points.

The information may be derived from neighbor discovery messages.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained by one skilled in the art and it is intended that the present disclosure encompass all such changes, substitutions, variations, alterations, and/or modifications as falling within the scope of the appended claims.

What is claimed is:

1. A method, comprising:
operating a cluster of access points in a wireless local area network, wherein at least some of the access points in the cluster operate in a Basic Service Set (BSS) privacy enhancement (BPE) mode;
collecting information from the at least some of the access points in the cluster while operating in the wireless local area network; and
selecting one of the access points in the cluster of access points to operate as a rendezvous point access point (RPAP) based on the information.

2. The method of claim 1, wherein the information is a number of probe requests received by the access points in the cluster of access points.

3. The method of claim 1, wherein the information is derived from neighbor discovery messages.

4. The method of claim 1, further comprising periodically rotating a media access control (MAC) address of the RPAP.

5. The method of claim 1, further comprising selecting another access point in the cluster of access points to operate as the RPAP based on information collected by the another access point in the cluster of access points while operating in the wireless local area network.

6. The method of claim 5, wherein the information collected by the another access point in the cluster of access points comprises a higher number of probe requests counted compared to a number of probe requests counted by the one of the access points in the cluster of access points.

7. The method of claim 1, further comprising identifying at least two access points in the cluster of access points as candidate RPAPs.

8. The method of claim 7, further comprising successively operating, one at a time, the candidate RPAPs.

9. The method of claim 7, further comprising operating each candidate RPAP for a random period of time.

10. The method of claim 1, further comprising collecting the information collected by the one of the access points during a training and stabilization period for the wireless local area network.

11. A device comprising:
an interface configured to enable network communications;
a memory, and
one or more processors coupled to the interface and the memory, and configured to:
operate a cluster of access points in a wireless local area network, wherein at least some of the access points in the cluster operate in a Basic Service Set (BSS) privacy enhancement (BPE) mode;
collect information from the at least some of the access points in the cluster while operating in the wireless local area network; and
select one of the access points in the cluster of access points to operate as a rendezvous point access point (RPAP) based on the information.

12. The device of claim 11, wherein the information is a number of probe requests received by the access points in the cluster of access points.

13. The device of claim 11, wherein the information is derived from neighbor discovery messages.

14. The device of claim 11, wherein the one or more processors are further configured to periodically rotate a media access control (MAC) address of the RPAP.

15. The device of claim 11, wherein the one or more processors are further configured to select another access point in the cluster of access points to operate as the RPAP based on information collected by the another access point in the cluster of access points while operating in the wireless local area network.

16. The device of claim 15, wherein the information collected by the another access point in the cluster of access points comprises a higher number of probe requests counted compared to a number of probe requests counted by the one of the access points in the cluster of access points.

17. The device of claim 11, wherein the one or more processors are further configured to identify at least two access points in the cluster of access points as candidate RPAPs.

18. One or more non-transitory computer readable storage media encoded with instructions that, when executed by a processor, cause the processor to:
operate a cluster of access points in a wireless local area network, wherein at least some of the access points in the cluster operate in a Basic Service Set (BSS) privacy enhancement (BPE) mode;
collect information from the at least some of the access points in the cluster while operating in the wireless local area network; and
select one of the access points in the cluster of access points to operate as a rendezvous point access point (RPAP) based on the information.

19. The one or more non-transitory computer readable storage media of claim 18, wherein the information is a number of probe requests received from the access points in the cluster of access points.

20. The one or more non-transitory computer readable storage media of claim 18, wherein the information is derived from neighbor discovery messages.
